(19) United States
(12) Patent Application Publication
(10) Pub. No.: US 2014/0250426 A1
(43) Pub. Date: Sep. 4, 2014

(54) PAGE TESTING METHOD AND PAGE TESTING APPARATUS

(71) Applicant: Huawei Technologies Co., Ltd., Shenzhen (CN)

(72) Inventors: Feng Wang, Nanjing (CN); Wei Miao, Nanjing (CN)

(73) Assignee: Huawei Technologies Co., Ltd., Shenzhen (CN)

(21) Appl. No.: 14/279,616

(22) Filed: May 16, 2014

Related U.S. Application Data
(63) Continuation of application No. PCT/CN2012/073646, filed on Apr. 9, 2012.

(30) Foreign Application Priority Data
Nov. 18, 2011 (CN) 201110367655.9

(51) Int. Cl. G06F 11/36

(52) U.S. Cl. CPC G06F 11/3668
USPC 717/124

(57) ABSTRACT

Embodiments of the present invention provide a page testing method and a page testing apparatus. The page testing method is used to test a page. The method includes: reading a test sentence used to indicate a page element and a test action; searching for a position where the page element is located on the page according to source code of the page; executing the test action in the position; and verifying an execution result of the test action to obtain a test result. According to the embodiments of the present invention, no action function is needed and instead, a specified test action is triggered directly. Therefore, the complexities of developing and using test software are reduced.

### CROSS-REFERENCE TO RELATED APPLICATIONS

This application is a continuation of International Application No. PCT/CN2012/073646, filed on Apr. 9, 2012, which claims priority to Chinese Patent Application No. 201110367655.9, filed on Nov. 18, 2011, both of which are hereby incorporated by reference in their entireties.

### TECHNICAL FIELD

The present invention relates to page testing technologies, and in particular, to a page testing method and a page testing apparatus.

### BACKGROUND

A third generation software testing technology characterized by an action word (Action Word, AW) has been a great success since its release for its ease of use.

In this software testing technology, a test software vendor defines in advance a corresponding action function for each standard action (such as “left-click on button” or “left-click on drop-down list box”) executed on a standard page (such as a standard web page compiled based on the HyperText Markup Language (HTML). The action function is identified by a corresponding action name (such as “left-click on button” or “left-click on drop-down list box”) and its purpose is not to trigger the corresponding action but to trigger an immediate result generated after the action is executed. The immediate result may be referred to as an action event. The test software maintains an action list that includes various action functions identified by their action names.

During a testing process, the test software first extracts all page elements (such as “buttons” and “drop-down list boxes”) on a page to be tested and generates a mapping table (MAP). Then, a test person can select an action name in the action list and select a page element in the mapping table to generate a corresponding test sentence, so as to test a particular action (that is, an action corresponding to the action name) on the page element. Next, after the page to be tested is loaded (the purpose is to set the page to a working state so as to test the page), the test software reads the test sentence and invokes the action function corresponding to the action name to trigger the action event resulting from the execution of the corresponding action on the page element in the test sentence, thereby obtaining and verifying the final action result (where the action result may be reflected by a change of the page) and obtaining the final test result. As stated above, the purpose of executing the action function is not to trigger the corresponding action but to trigger the immediate result generated after the action is executed.

As stated above, in the above testing process, the test person needs to select an action name and a page element to generate a corresponding test sentence. For example, if the test person needs to test the page action “left-click on login button”, the test person needs to first select the action name “left-click on button” and then select the page element “login button” to generate the corresponding test sentence. For another example, if the test person needs to test the page action “left-click on gender drop-down list box”, the test person needs to first select the action name “left-click on drop-down list box” and then select the page element “gender drop-down list box” to generate the corresponding test sentence. It is not difficult to notice that the test person needs to select the corresponding action name (such as “left-click on button” or “left-click on drop-down list box”) according to two reference conditions, the action type (such as “left-click”) and the type of the page element to be tested which is targeted at by the action to be tested (for example, the type of “login button” is “button” and the type of “gender drop-down list box” is “drop-down list box”) so as to determine the corresponding action function, but cannot select the corresponding action name according to only the action type. This is because the action event triggered after the action is executed is probably different in the case of different types of page elements even if the action type is the same (for example, a left-click on the “login button” may result in the popup of a login result page and a left-click on a “drop-down list box” may result in the listing of available options). Therefore, corresponding action functions need to be developed according to the types of page elements. The difference in the action functions caused by different types of page elements increases the complexity of the test software. On the one hand, even for a same type of actions, the test software vendor still needs to compile different action functions according to the type of the page element targeted at by the action, which increases the complexity of developing test software. On the other hand, when selecting an action function, the test person needs to select the required action function further from a number of similar action functions according to the type of the page element targeted at by the action, which increases the complexity of using test software.

### SUMMARY

In view of this, it is necessary to provide a page testing method in order to reduce the complexities of developing and using existing test software.

Meanwhile, a page testing apparatus is provided in order to reduce the complexities of developing and using existing test software.

According to one aspect of embodiments of the present invention, a page testing method used to test a page is provided, where the method includes:

reading a test sentence used to indicate a page element and a test action;

searching for a position where the page element is located on the page according to source code of the page;

executing the test action in the position; and

verifying an execution result of the test action to obtain a test result.

According to another aspect of the embodiments of the present invention, a page testing apparatus used to test a page is provided, where the apparatus includes:

a reading module, configured to read a test sentence used to indicate a page element and a test action;

a search module, configured to search for a position where the page element is located on the page according to source code of the page;

an executing module, configured to execute the test action in the position; and

a verifying module, configured to verify an execution result of the test action to obtain a test result.

According to the technical solutions provided in the embodiments of the present invention, a test sentence used to indicate a page element and a test action is read; a position where the page element is located on a page is searched for according to source code of the page; the test action is executed in the position; and then an execution result of the test action is verified to obtain a test result. It can be seen that, no action function is needed in the embodiments of the present invention and instead, a specified test action is triggered directly. Therefore, the complexities of developing and using test software are reduced.

### BRIEF DESCRIPTION OF THE DRAWINGS

To illustrate the technical solutions in the embodiments of the present invention more clearly, the following briefly introduces the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is an exemplary flowchart of a page testing method according to an embodiment of the present invention;

FIG. 2 is an exemplary schematic logical structural diagram of a page testing apparatus according to an embodiment of the present invention; and

FIG. 3 is an exemplary schematic diagram of a page according to an embodiment of the present invention.

### DETAILED DESCRIPTION

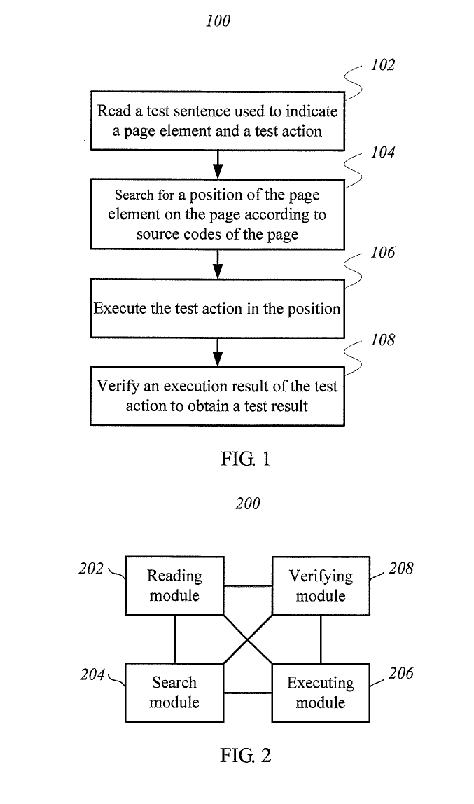

FIG. 1 is an exemplary flowchart of a page testing method 100 according to an embodiment of the present invention. The page testing method 100 is used to test a page, where the page may be a Web Page compiled based on the HTML or may be a software interface.

Step 102: Read a test sentence used to indicate a page element and a test action.

Step 104: Search for a position where the page element is located on the page according to source code of the page.

Step 106: Execute the test action in the position.

Step 108: Verify an execution result of the test action to obtain a test result.

According to the technical solution provided in the embodiment of the present invention, a test sentence used to indicate a page element and a test action is read; a position where the page element is located on a page is searched for according to source code of the page; the test action is executed in the position; and then an execution result of the test action is verified to obtain a test result. It can be seen that, no action function is needed in the embodiments of the present invention and instead, a specified test action is triggered directly. Therefore, the complexities of developing and using test software are reduced. In addition, in the embodiments of the present invention, it is unnecessary to extract in advance all page elements on a page to be tested to generate a mapping table.

The steps in the method 100 will be described in detail below.

In a specific implementation process, the test sentence mentioned in step 102 may be a test sentence based on a natural language and input based on a preset sentence template. The sentence template corresponds to an action keyword, and different action keywords correspond to different sentence templates. For example, for the action keyword “left-click”, the corresponding sentence template may adopt the following format:

left-click+page element

“+” does not need to be input. The page element may be but is not limited to such page elements as “login button” and “gender drop-down list box”. For another example, for the action keyword “input”, the corresponding sentence template may adopt the following format:

input+action value+in+page element

“+” does not need to be input. Unlike the action keyword “left-click”, the sentence template corresponding to the action keyword “input” needs to include an action value, where the action value may be any character required to be input, such as a string formed by at least one type in numeric values, symbols, and alphabetic letters. It is not difficult to notice that, in a test sentence input based on a sentence template, a test action indicated by the test sentence is an action indicated by an action keyword corresponding to the sentence template. In addition, after the action keyword included in the test sentence is determined, the page element and action value (if an action value is included) indicated by the test sentence can be obtained by parsing according to the sentence template corresponding to the action keyword. In a specific implementation process, the test action may include but is not limited to such actions as left-click, right-click, double left-click, double right-click, hover, keyboard input, and scroll. It can be seen that, compared with an action name that identifies an action function in the prior art, an action keyword is only an action type and does not include the type of the page element targeted at by the action.

In addition, the page element mentioned in the sentence template may be indicated jointly by content and a type of the page element, or indicated by an attribute of the page element (including an attribute name and attribute value), or indicated jointly by content and a type of the page element and an attribute of the page element, so as to indicate the page element more accurately. For example, for a page element “staff id field”, in the test sentence, the page element may be indicated by the content and type of the page element, that is, words “staff id” and “field”, or indicated by the attribute name of the page element such as id or name and its corresponding attributed value, or indicated jointly by the words “staff id” and “field” and the attribute id or name and its corresponding attribute value. When the test sentence includes both the content and type of the page element and the attribute name and its attribute value, the page element in the sentence template may adopt the following format in the test sentence:

content of page element+type of page element (attribute name of page element=attribute value)

“+” does not need to be input. For example, the page element “staff id field” on the page may be written as “staff id field (id=staff)”, where staff id is the content of the page element, field is the type of the page element, id is the attribute name of the page element, and staff is the attribute value of the page element. More specifically, when the attribute name of the page element is used in the test sentence, the attribute name may be uniformly identified as a general variable, such as general variable X, where the general variable X may be id, name, or other attribute names. In this case, the page element will be indicated by the value of the general variable X. For example, the page element “staff id field” may be written as X=staff, and in this case, the page element is a page element with an attribute value being “staff” regardless of the attribute name of the attribute corresponding to the attribute value.

As stated above, in the test sentence based on a natural language and input based on the sentence template, the test action is indicated by an action keyword, and the page element is indicated by the content and type of the page element, or indicated by the attribute name and attribute value of the page element, or indicated jointly by the content and type of the page element and the attribute name and attribute value of the page element. For ease of description, the information used to indicate the page element in the test sentence may be described as page element indication information. From the above description, it is not difficult to understand that the page element indication information includes at least one type of the following information:

content and type of the page element; and

attribute name and attribute value of the page element.

The page element indication information may include the content and type of the page element, or include the attribute name and attribute value of the page element, or include both the content and type of the page element and the attribute name and attribute value of the page element.

In addition, in a specific implementation process, the sentence template may be implemented by adopting a regular expression. For example, the regular expression corresponding to the action keyword “input” may be:

input [″′″](?P<value>.*)[″′″] in

[″′″](?P<text>.*)[″′″][field or box]?([(](?P<X>[\w]*)
=(?P<V>.*)[))])?([[ ]((?P<index>[\d]+?)(?P<offset>([\+\−][\d]+)?))
[ ]])?[field or box]?

In the regular expression, the “text” may represent the content of the page element, “field or box” indicates that the type of the page element is field or box, “X” represents a general variable, “V” represents the value of the general variable, and “value” is the action value. It can be seen that, in the test sentence input according to the regular expression, the page element indication information includes both the content and type of the page element and the attribute name and attribute value of the page element.

From the above description, it can be known that, if the sentence template corresponding to the test sentence is known, the page element indicated by the test sentence can be obtained by parsing the test sentence. Because sentence templates correspond to action keywords, if the action keyword included in the test sentence is known, the sentence template corresponding to the test sentence is known. In a specific implementation process, an action keyword list may be maintained where various action keywords are listed. In this case, step 102 in the method 100 may specifically include:

reading the test sentence;

searching, based on the action keyword list, for an action keyword included in the test sentence, where the action keyword is used to indicate the test action; and

extracting the page element from the test sentence according to a sentence template corresponding to the action keyword, where the extracting the page element from the test sentence may be specifically explained as extracting the page element indication information of the page element.

In addition, step 102 in the method 100 may further include extracting, from the test sentence according to the sentence template corresponding to the action keyword, an action value associated with the test action.

As stated above, in step 104 of the method 100 in the embodiment of the present invention, the position where the page element is located on the page is searched for according to the source code of the page. Specifically, the position is in a visual scope. In a specific implementation process, when a page is tested, the page usually needs to be loaded, that is, the source code of the page need to be loaded to a memory. In this way, the position where the page element is located on the page can be searched for according to the source code of the page loaded to the memory. It can be known from the background that, the page needs to be loaded twice in the prior art. The purpose of the first page loading is to extract all page elements on the page to generate a mapping table and the purpose of the second page loading is to set the page to a working state so as to test the page. Compared with the prior art, in the embodiment of the present invention, it is unnecessary to extract all page elements on the page to generate a mapping table, and therefore, the page needs to be loaded for only once.

In a specific implementation process, step 104 in the method 100 may specifically include: making the page element appear in a visual scope; searching, according to the source code of the page, for a position where the page element is located in a window object to which the page element belongs; searching for, according to the source code of the page, a position where the window object to which the page element belongs is located on the page; searching, according to the source code of the page, for a current scroll position of a scroll bar that influences a display position of the window object; determining the position where the page element is located on the page according to the position where the page element is located in the window object to which the page element belongs, the position where the window object to which the page element belongs is located on the page, and the current scroll position of the scroll bar that influences the display position of the window object. In a specific implementation process, the step 104 may be implemented through the following code:

def getAbsPosition(self, elem):

“‘Get coordinates of the specified page element

Input: elem - page element
Return: coordinates [x, y] of the page element
Note: If the page element is outside the visual scope, the

page element is moved into the visual scope automatically”’

#Return value
pos = [0, 0]
#First move the page element into the visual scope
elem.scrollIntoView(False)
#Prepare a cycle
tempelem = elem
#Get the position of the elem relative to the window

through accumulation of relative positions within a document

#Finally get the absolute position of the window and

add it to get the absolute position of the elem

while True:

#x-axis
pos[0] += tempelem.offsetLeft
#y-axis
pos[1] += tempelem.offsetTop
logger.debug(“[%d, %d],%s” % (pos[0], pos[1],

tempelem.tagName))

#The getting operation should stop at BODY and an

error of offsetParent will be reported if the operation goes further

#Now get the absolute position of the window
if tempelem.tagName == “BODY”:

curWindow

tempelem.ownerDocument.parentWindow

pos[0] += curWindow.screenLeft
#BUG in IE: The screenTop attribute is inaccurate,

but this can be solved by using Windows XP sp3

#pos[1] += curWindow.screenTop
pos[1] += curWindow.screenTop

logger.debug(“curWindow.screenTop=%d,name=%s” %

(curWindow.screenTop, curWindow.location))
logger.debug(“curWindow.parent.screenTop=%d,name=%s” %
(curWindow.parent.screenTop, curWindow.parent.location))
logger.debug(“curWindow.parent.parent.screenTop=%d,name=%s” %
(curWindow.parent.parent.screenTop,
curWindow.parent.parent.location))
logger.debug(“curWindow.parent.parent.parent.screenTop=%d,name=%s
” % (curWindow.parent.parent.parent.screenTop,
curWindow.parent.parent.parent.location))
logger.debug(“curWindow.parent.parent.parent.parent.screenTop=%d,
name=%s” % (curWindow.parent.parent.parent.parent.screenTop,
curWindow.parent.parent.parent.parent.location))
logger.debug(“curWindow.top.screenTop=%d,name=%s” %
(curWindow.top.screenTop, curWindow.top.location))
logger.debug(“curWindow.top.frames[0].screenTop=%d” %
curWindow.top.frames[0].screenTop)

#Now getting the absolute position of the elem

is completed, and adjustment will be made according to the state of
the scroll bar.

while tempelem:

if hasattr(tempelem, ‘scrollLeft’):

if tempelem.scrollLeft != 0:

logger.debug (“detect on %s that the

scroll bar shifts right by %d” % (tempelem.tagName,
tempelem.scrollLeft))

#scrollLeft is the distance of right

shifting of the scroll bar

pos[0] −= tempelem.scrollLeft

if hasattr(tempelem, ‘scrollTop’):

if tempelem.scrollTop != 0:

logger.debug (“detect on %s that the

scroll bar shifts downward by %d” % (tempelem.tagName,
tempelem.scrollLeft))

#scrollTop is the distance of

vertical shifting of the scroll bar

pos[1] −= tempelem.scrollTop

#Get the parent node
tempelem = tempelem.parentNode

break
#Get the upper level element and prepare the next

cycle

tempelem = tempelem.offsetParent

try:

#If the height and width of the page element can

be got, it is better to return the central position where the page
element is located

pos[0] += int((elem.clientwidth) / 2)
pos[1] += int((elem.clientHeight) / 2)

#

#----------------------------------------------------------------
--------------------------

# #This is unneeded, and it only needs to just set

the page element in the visual scope when the function starts

# #The purpose is to check whether the got position

is in the scope of the window, and if not, move the page element into
the visual scope and then get its current visible position through
recursion.

#

#----------------------------------------------------------------
--------------------------

# #Determine whether the returned position is in the

scope of the interface to solve the problem that some positions can
be displayed only after scrolling.

# hwnd = win32gui.FindWindow(“IEFrame”,

systemparam[‘IETitle’])

# ierect = win32gui.GetWindowRect(hwnd)
# point = QtCore.QPoint(pos[0], pos[1])
# if not (pos[0] >= ierect[0] and pos[0] <= ierect[2]

and pos[1] >= ierect[1] and pos[1] <= ierect[3]):

# logger.debug (“the position %s of the page

element is not in the scope of the current interface %s and scrolling
is needed” % (point, ierect)

# elem.scrollIntoView(False)
# #Note that a direct return is needed herein,

or otherwise the original value is finally returned

# return self.getAbsPosition(elem)

except:

#If the height and width of the page element cannot

be got, only the upper left position where the page element is located
can be returned

logger.debug (“getting the

clientWidth/clientHeight attribute of the page element fails and only
the upper left corner can be clicked. \n%s” % traceback.format_exc( ))

#Do not use “finally” if there is recursion because

“finally” will be executed and there will be two returns

finally:

logger.debug (“get the position where the page

element is located %s” % pos)

#If the main window blocks the position, the main window

should be moved to display the position

if systemparam[‘withGUI’]:

#Send the position where the mouse works to the GUI

so that the GUI determines whether it blocks the position, and if so,
gives way actively

#Send the current position in the form of a string,

like “x, y” (exclusive of quotation marks)
ui.MainWindow.emit(QtCore.SIGNAL(“c_signal_move_main_window(QStri
ng)”), str(pos[0]) + ‘,’ + str(pos[1]))

return pos

The process described by the above code may be roughly described as: making the page element appear in the visual scope; accumulating an of f set between each element and its upper level element among elements at all levels (inclusive of the page element to be tested) between the page element to be tested and a body element of the window object to which the page element to be tested belongs, to get an offset between the page element to be tested and the body element as the position where the page element is located in the window object to which the page element belongs; getting the position of the body element of the window object to which the page element to be tested belongs on the page as the position where the window object to which the page element belongs is located on the page; and finally getting the position where the page element is located on the page according to the position where the page element is located in the window object to which the page element belongs, the position where the window object to which the page element belongs is located on the page, and the current scroll position of the scroll bar that influences the display position of the window object.

The last part of the above code is used to guarantee that the test window will not block the page element to be tested, thereby avoiding the inability to execute the test action on the page element to be tested. The content about the test window will be described in detail below.

In addition, a person skilled in the art should understand that other methods may be used to search for the position where the page element is located on the page according to the source code of the page.

It should be noted that, in a specific implementation process, the page element indication information carried in the test sentence may not be capable of uniquely locating the position where the page element is located to be tested. For example, for pages whose source code is not normalized, it is possible that the same attribute value is assigned to the same attribute name of different page elements. As a result, if the page element indication information includes only the attribute name and the attribute value, multiple positions will be located, that is, multiple corresponding page elements will be found. One solution to the above problem is to include the page element indication information of another page element in the test sentence in addition to the page element indication information of the page element to be tested, where the page element indication information of the page element to be tested cannot uniquely locate the position where the page element is located to be tested on the page, but the page element indication information of the another page element can uniquely locate the position of the another page element on the page. In this case, the test sentence further includes information about the position relationship between the page element to be tested and the another page element, so that the position where the page element is located to be tested on the page can be located according to the information about the position relationship between the page element to be tested and the another page element when the position of the another page element is located according to the page element indication information of the another page element In addition, another solution to the problem may be to add a position sequence number in the test sentence. In this case, when multiple positions are found according to the page element indication information of the page element to be tested, the multiple positions may be sorted according to a certain direction, such as a browse direction of the page. Afterward, the corresponding position is found among the sorted multiple positions according to the position sequence number and used as the position where the page element is located on the page. In some cases, the action result caused by the execution of the test action on one page element on the page to be tested may appear on another page and therefore, verification needs to be carried out on the another page. For example, when a login operation is tested, it is usually necessary to verify a login result on a login result page popping up after the login operation is executed. In this case, it is possibly necessary to locate the position of the login result page element on the login result page so as to obtain the login result. Therefore, in a specific implementation process, according to the technical solution provided in the embodiment of the present invention, the source code of multiple associated pages may also be loaded simultaneously. In this case, when the page element indicated by the test sentence is located, it is necessary to first locate, according to the source code of the pages, the page where the page element is located and then locate the position where the page element is located on the page. This is because the test sentence does not indicate the page where the page element is located. When the source code of multiple pages is loaded, there will be a large quantity of source code and therefore, it is time-consuming to locate the page where the page element is located and the position where the page element is located on the page. To solve the problem, in the embodiment of the present invention, it is allowed to preferentially determine, according to the source code of the page element indicated by a previous test sentence, whether the page element indicated by the current test sentence appears on the page where the page element indicated by the previous test sentence is located, because the page elements indicated by two successive test sentences are likely located on the same page. In addition, in the embodiment of the present invention, according to the executed test sentences, the numbers of hits of pages where the page elements indicated by the test sentences are located are counted and the pages are sorted according to the numbers of hits. For example, in the executed test sentences, the page elements indicated by three test sentences appear on the first page, and the page elements indicated by two test sentences appear on the second page. Accordingly, the number of hits of the first page is 3 and the number of hits of the second page is 2. In this case, when the page where the page element indicated by the current test sentence is located is determined, it is allowed to preferentially determine whether the page element to be tested appears on the page that is hit more times.

Ina specific implementation process, step 106 may specifically include: moving a cursor to the position where the page element is located on the page, which is obtained in step 104, and then executing the test action, such as “left-click” and “input”. In a specific implementation process, when the cursor is moved, an unnecessary onmouseover event may be triggered. Specifically, an onmouseover event is an event triggered when the cursor is moved onto a page element. When the cursor is moved to the position where the page element is located to be tested, an onmouseover event is possibly triggered when the cursor passes through another page element. The onmouseover event may have unexpected effects on the testing process. Therefore, in a specific implementation process, the cursor may first be moved to another position and then moved from that position to the position where the page element is located to be tested on the page. When the cursor is moved from that position to the position where the page element is located to be tested on the page, no unnecessary onmouseover event is triggered. In a specific operation process, the positions of page elements that will trigger onmouseover events on the page to be tested may be first located and then a cursor moving path may be planned, so that the page elements that will trigger onmouseover events do not appear in the moving path. A typical example of the moving path is a right-angle path, that is, a line connecting the current position of the cursor and another position and a line connecting the another position and the position where the page element is located to be tested on the page intersect to form a right angle.

In a specific implementation process, when the action required to be executed is input (that is, the action keyword found in the test sentence according to the action keyword list is “input”), the executing the test action specifically includes: copying the action value and pasting it into the position where the page element is located to be tested on the page. By using the copy and paste method, the problem of switching input methods can be effectively avoided when non-English characters such as Chinese characters are input. It can be seen that, compared with the prior art, in the embodiment of the present invention, it is only necessary to execute the action in the test sentence without considering the action object, that is, the type of the page element.

Finally in step 108, the execution result of the test action is verified to obtain a test result. Specifically, after the execution result is obtained, if the execution is the same as expected, it indicates that the test is successful, that is, the test result is success; and if the execution result is different from the expected result, it indicates that the test fails, that is, the test result is failure.

In addition, in a specific implementation process, the method 100 may further include: displaying a test window that uses preset transparency, where the position where the page element is located on the page is outside the test window and the test window includes a first sub-window used to display the test sentence and a second sub-window used to display the test result; before the test result is obtained, the test sentence takes on a first color; after the test result is obtained, if the test result is success, the test sentence takes on a second color and the test result takes on a third color; after the test result is obtained, if the test result is failure, the test sentence takes on a fourth color and the test result takes on a fifth color, where the first color, the second color, and the fourth color are different from each other, and the third color is different from the fifth color.

The test window is set to have certain transparency, so as to guarantee that the test window does not completely block the page to be tested. The purpose of guaranteeing that the position where the page element is located on the page is outside the test window is to make sure that the test window will not block the page element to be tested, thereby avoiding the inability to execute the test action on the page element to be tested. For example, assuming that the test sentence indicates that a left-click is required on the page element to be tested, if the page element to be tested is blocked by the test window, it is impossible to click the page element to be tested and what is clicked is the test window. To ensure that the page element to be tested is not blocked by the test window, the position of the test window may be designed as variable or fixed. If the position of the test window is variable, it should be guaranteed that the test window does not block the page element currently being tested. That is, if the test window blocks the page element indicated by the test sentence to be executed, the position of the test window should be changed. If the position of the test window is fixed, it should be guaranteed that the test window blocks no page element on the page. Marking test sentences with different colors before and after the test may help to distinguish which test sentences have been executed and which have not been executed yet. Marking the executed test sentences with different colors according to different test results may help to distinguish the final test results of which test sentences are success and the final test results of which test sentences are failure. Marking the test results with different colors according to different test results may help to distinguish which test results are acceptable and which are not. Marking with different colors may help the test person to quickly locate test sentences that fail the test. In addition, the test window may further include a third window used to display the test sentence currently being executed.

In a specific implementation process, the method 100 may further include: outputting operation exception prompt information when the test sentence cannot be recognized. The operation exception prompt information may include multiple options, one of which, for example, may be skipping the test sentence, executing the next test sentence and also marking the unrecognizable test sentence. Another option may be executing the test sentence manually, that is, the test person executes the action indicated by the test sentence on the page element indicated by the test sentence. In addition, the method 100 may further include: receiving the option selected by the test person and executing the corresponding operation. For example, when the option selected by the test person is to skip the test sentence, execute the next test sentence and at the same time mark the unrecognizable test sentence, the unrecognizable test sentence is marked and the method 100 is executed again on the next sentence. Definitely, the method 100 may further include: when the test sentence cannot be recognized, skipping the test sentence, executing the next test sentence directly, and at the same time marking the unrecognizable test sentence.

An embodiment of the present invention further provides a page testing apparatus, which will be described in detail below with reference to FIG. 2.

FIG. 2 is an exemplary schematic logical structural diagram of a page testing apparatus 200 according to an embodiment of the present invention. The apparatus 200 is used to test a page. The apparatus 200 specifically includes a reading module 202, a search module 204, an executing module 206, and a verifying module 208.

The reading module 202 is configured to read a test sentence used to indicate a page element and a test action.

The search module 204 is configured to search for a position where the page element is located on the page according to source code of the page.

The executing module 206 is configured to execute the test action in the position.

The verifying module 208 is configured to verify an execution result of the test action to obtain a test result.

In a specific implementation process, the search module 204 is specifically configured to:

make the page element appear in a visual scope, for example, by moving a scroll bar;

search, according to the source code of the page, for a position where the page element is located in a window object to which the page element belongs;

search, according to the source code of the page, for a position where the window object to which the page element belongs is located on the page;

search, according to the source code of the page, for a current scroll position of a scroll bar that influences the display position of the window object; and

determine the position where the page element is located on the page according to the position where the page element is located in the window object to which the page element belongs, the position where the window object to which the page element belongs is located on the page, and the current scroll position of the scroll bar that influences the display position of the window object.

As stated above, the test sentence carries page element indication information used to indicate the page element, and the search module 204 is specifically configured to search for the position where the page element is located on the page according to the page element indication information, where the page element indication information includes content and a type of the page element, or includes an attribute name and attribute value of the page element, or includes both content and a type of the page element and an attribute name and attribute value of the page element.

In a specific implementation process, the reading module 202 is specifically configured to:

read the test sentence;

search, based on an action keyword list, for an action keyword included in the test sentence, where the action keyword is used to indicate the test action; and

extract the page element from the test sentence according to a sentence template corresponding to the action keyword.

In a specific implementation process, the reading module 202 is further configured to:

extract, from the test sentence according to the sentence template corresponding to the action keyword, an action value associated with the test action.

In a specific implementation process, the executing module 206 is specifically configured to: when the found action keyword is input, copy the action value and paste it into the position.

In a specific implementation process, the apparatus 200 may further include:

a displaying module (not shown in FIG. 2), configured to display a test window that uses preset transparency, where the position where the page element is located on the page is outside the test window and the test window includes a first sub-window used to display the test sentence and a second sub-window used to display the test result; before the test result is obtained, the test sentence takes on a first color; after the test result is obtained, if the test result is success, the test sentence takes on a second color and the test result takes on a third color; and, after the test result is obtained, if the test result is failure, the test sentence takes on a fourth color and the test result takes on a fifth color, where the first color, the second color, and the fourth color are different from each other, and the third color is different from the fifth color.

It should be noted that, in specific implementation processes, the operations executed by the apparatus 200 shown in FIG. 2 correspond to the method 100 shown in FIG. 1, and therefore, for other related operations of the apparatus 200, reference may be made to the method 100, which will not be repeated herein.

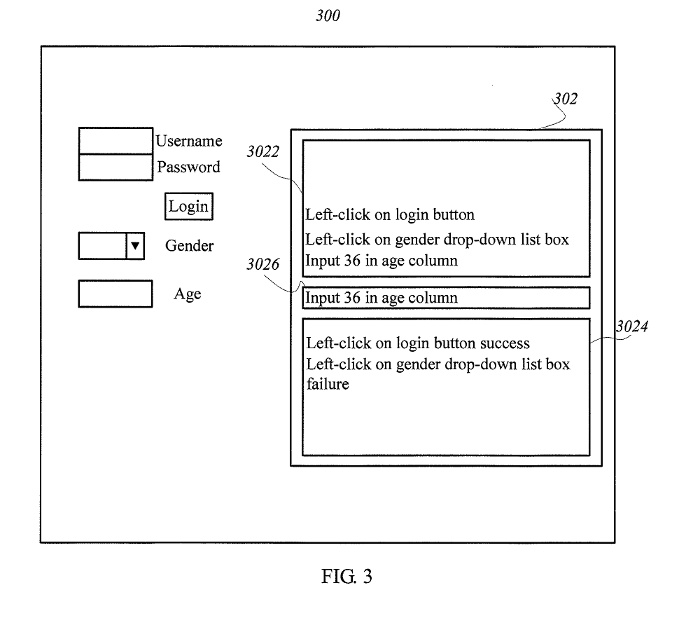

FIG. 3 is an exemplary schematic diagram of a page 300 according to an embodiment of the present invention. As shown in FIG. 3, the page 300 displays a username input field, a password input field, a login button, a gender drop-down list box, an age input field, and a test window 302. The test window 302 further includes a first sub-window 3022, a second sub-window 3024, and a third sub-window 3026. As stated above, the first sub-window 3022 is configured to display a test sentence, the second sub-window 3024 is configured to display a test result, and the third sub-window 3026 is configured to display a test sentence currently being executed.

As shown in FIG. 3, the first sub-window 3022 lists three test sentences: left-click on login button, left-click on gender drop-down list box, and input 36 in age field, where the left-click on login button and left-click on gender drop-down list box have been completely executed. The test results displayed in the second sub-window 3024 are respectively success and failure. “Input 36 in age field” is also displayed in the third sub-window 3026, which means that the test sentence is being executed. As stated above, in a specific implementation process, the test window 302 may use preset transparency (not shown in the figure), the test sentences in the first sub-window may be displayed in different colors in different circumstances (not shown in the figure), and the test results in the second sub-window may also be displayed in different colors in different circumstances (not shown in the figure). The specific display of colors is already described above clearly and will not be repeated herein.

An embodiment of the present invention further provides a page testing apparatus, including a memory and a processor, where the memory stores computer readable instructions used to execute the method 100 and the processor is configured to read the computer readable instructions stored in the memory so as to execute the method 100 shown in FIG. 1.

An embodiment of the present invention further provides a computer readable medium, which stores computer readable instructions used to execute the method 100 shown in FIG. 1.

A person of ordinary skill in the art know that all or a portion of the steps in the foregoing method may be completed by related hardware under the instruction of a program. The program may be stored in a computer readable storage medium. The computer readable storage medium may be a ROM, a RAM, or a CD-ROM and so on.

To sum up, the foregoing embodiments are merely exemplary embodiments of the present invention, but are not intended to limit the protection scope of the present invention. Any modifications, equivalent replacements, and improvements made to the present invention without departing from the spirit and principle of the present invention shall fall within the protection scope of the present invention.

What is claimed is:

1. A page testing method used to test a page, the method comprising:
reading a test sentence used to indicate a page element and a test action;
searching for a position where the page element is located on the page according to source code of the page;
executing the test action in the position; and
verifying an execution result of the test action to obtain a test result.

2. The method according to claim 1, wherein searching for a position where the page element is located on the page according to source code of the page comprises:
making the page element appear in a visual scope;
searching, according to the source code of the page, for a position where the page element is located in a window object to which the page element belongs;
searching, according to the source code of the page, for a position where the window object to which the page element belongs is located on the page;
searching, according to the source code of the page, for a current scroll position of a scroll bar that influences a display position of the window object; and
determining the position where the page element is located on the page according to the position where the page element is located in the window object to which the page element belongs, the position where the window object to which the page element belongs is located on the page, and the current scroll position of the scroll bar that influences the display position of the window object.

3. The method according to claim 2, wherein:
the test sentence carries page element indication information used to indicate the page element; and
searching for a position where the page element is located on the page specifically comprises:
searching for the position where the page element is located on the page according to the page element indication information, wherein the page element indication information comprises content and a type of the page element, or an attribute name and attribute value of the page element, or both content and a type of the page element and an attribute name and attribute value of the page element.

4. The method according to claim 3, wherein reading a test sentence used to indicate a page element and a test action comprises:
reading the test sentence;
searching, based on an action keyword list, for an action keyword comprised in the test sentence, wherein the action keyword is used to indicate the test action; and
extracting the page element from the test sentence according to a sentence template corresponding to the action keyword.

5. The method according to claim 4, wherein reading a test sentence used to indicate a page element and a test action further comprises:
extracting, from the test sentence according to the sentence template corresponding to the action keyword, an action value associated with the test action.

6. The method according to claim 5, wherein, when the found action keyword is input, and executing the test action comprises: copying the action value and pasting it into the position.

7. The method according to claim 6, wherein the method further comprises:
displaying a test window that uses preset transparency, wherein the position where the page element is located on the page is outside the test window and the test window comprises a first sub-window used to display the test sentence and a second sub-window used to display the test result;
before the test result is obtained, the test sentence takes on a first color;
after the test result is obtained, if the test result is success, the test sentence takes on a second color and the test result takes on a third color;
after the test result is obtained, if the test result is failure, the test sentence takes on a fourth color and the test result takes on a fifth color; and
wherein the first color, the second color, and the fourth color are different from each other, and the third color is different from the fifth color.

8. A page testing apparatus used to test a page, the apparatus comprising:
a reading module, configured to read a test sentence used to indicate a page element and a test action;
a search module, configured to search for a position where the page element is located on the page according to source code of the page;
an executing module, configured to execute the test action in the position; and
a verifying module, configured to verify an execution result of the test action to obtain a test result.

9. The apparatus according to claim 8, wherein the search module is configured to:
make the page element appear in a visual scope;
search, according to the source code of the page, for a position where the page element is located in a window object to which the page element belongs;
search, according to the source code of the page, for a position where the window object to which the page element belongs is located on the page;
search, according to the source code of the page, for a current scroll position of a scroll bar that influences a display position of the window object; and
determine the position where the page element is located on the page according to the position where the page element is located in the window object to which the page element belongs, the position where the window object to which the page element belongs is located on the page, and the current scroll position of the scroll bar that influences the display position of the window object.

10. The apparatus according to claim 9, wherein the test sentence carries page element indication information used to indicate the page element, and the search module is configured to:
search for the position where the page element is located on the page according to the page element indication information, wherein the page element indication information comprises content and a type of the page element, or an attribute name and attribute value of the page element, or both content and a type of the page element and an attribute name and attribute value of the page element.

11. The apparatus according to claim 10, wherein the reading module is configured to:
read the test sentence;
search, based on an action keyword list, for an action keyword comprised in the test sentence, wherein the action keyword is used to indicate the test action; and
extract the page element from the test sentence according to a sentence template corresponding to the action keyword.

12. The apparatus according to claim 11, wherein the reading module is further configured to:
extract, from the test sentence according to the sentence template corresponding to the action keyword, an action value associated with the test action.

13. The apparatus according to claim 12, wherein, when the found action keyword is input, the executing module is configured to copy the action value and paste it into the position.

14. The apparatus according to claim 13, wherein the apparatus further comprises:
a displaying module, configured to display a test window that uses preset transparency, wherein the position where the page element is located on the page is outside the test window and the test window comprises a first sub-window used to display the test sentence and a second sub-window used to display the test result; before the test result is obtained, the test sentence takes on a first color; after the test result is obtained, if the test result is success, the test sentence takes on a second color and the test result takes on a third color; and, after the test result is obtained, if the test result is failure, the test sentence takes on a fourth color and the test result takes on a fifth color, wherein the first color, the second color, and the fourth color are different from each other, and the third color is different from the fifth color.
